(19) United States
(12) Patent Application Publication
(10) Pub. No.: US 2003/0137585 A1
(43) Pub. Date: Jul. 24, 2003

(54) Machine vision system

(76) Inventors: James Mahon, Dublin (IE); John Doherty, Dublin (IE); Andrew Harton, Dublin (IE); Patrick Smith, Dublin (IE); Mark Dullaghan, Trim (IE); Richard Frank Toftness, Loveland, CO (US)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 10/317,219

(22) Filed: Dec. 12, 2002

Related U.S. Application Data
(60) Provisional application No. 60/339,330, filed on Dec. 12, 2001.

(51) Int. Cl. H04N 5/225

(52) U.S. Cl. 348/135; 348/142; 348/262; 382/299

(57) ABSTRACT

In a machine vision system, four images are acquired from overlapping fields of view. There is sub-pixel movement between images of either half pixel or third pixel. The images are combined to provide a single image of higher resolution. The camera and the object are displaced relative to each other by movement of the camera on a gantry system or by tilting the lens with respect to the camera.

### FIELD OF THE INVENTION

The invention relates to capture and processing of images from a subject such as an electronics circuit board for machine vision.

### PRIOR ART DISCUSSION

At present, it is known to provide a machine system comprising a camera such as a CCD camera, and an XY table with a gantry. The gantry moves either the subject or the camera. For example, the camera may have a resolution of 1280×1024 pixels, for a pixel size of 25 microns resolution. This gives a field of view of 32×25 mm. Thus, 100 views are required to inspect a circuit board of size 320 mm×250 mm. The camera may have an acquisition time of, say, 50 msec. If the time for movement from view to view is on average 200 ms, the total time per view is 250 ms, giving four views per second and thus a total time of 25 secs for the full board (100 views).

If the board is to be inspected at 12.5 micron resolution, the prior approach has been to change the optics to reduce the pixel size to 12.5 microns. Thus 400 views are required. The camera acquisition will still take 50 msec, and the move time will reduce to 140 msec, allowing 5.2 views/second to be acquired. Thus the board can be inspected in 77 sec, more than 3 times longer than at 25 micron pixel size. In addition, there is the problem of having to split up large components that are greater than 16×12.5 mm but less then 32×25 mm.

The invention is therefore directed towards achieving a shorter time for full capture over a given area at higher resolution. The invention furthermore aims to achieve these objectives without needing to modify a conventional optical set-up of an inspection machine.

### SUMMARY OF THE INVENTION

According to the invention, there is provided a machine vision system comprising:

a controller;

a camera having a lens, and being for capturing images of an object under inspection;

movement means to change mutual position of the camera with respect to the object under inspection;

an image processor for processing the captured images;

the movement means comprising means for moving relative position of the camera with respect to the object to the extent of less than a camera pixel dimension;

the controller comprising means to direct the movement means and the camera to capture a plurality of images mutually offset by a fraction of a pixel; and

the image processor comprises means for combining said plurality of captured images to provide an output image having a higher resolution than the captured images.

In one embodiment, the captured images are offset by one half of a pixel width.

In another embodiment, the captured images are offset by one third of a pixel width.

In a further embodiment, the controller comprises means for dynamically controlling the movement means and the camera to capture a plurality of images offset by less than a pixel for a part of the object and to capture only one image for another part of the object.

In one embodiment, the controller comprises means for selecting an electronic component of a circuit object under inspection for capture of a plurality of images offset by less than a pixel.

In another embodiment, the controller comprises means for selecting an electronic component of a circuit object under inspection for capture of a plurality of images offset by less than a pixel; and wherein the controller comprises means for dynamically choosing which components require higher resolution inspection according to component attributes.

In a further embodiment, the controller comprises means for selecting an electronic component of a circuit object under inspection for capture of a plurality of images offset by less than a pixel; and wherein the controller comprises means for choosing which components require higher resolution inspection according to circuit design data.

In one embodiment, the controller comprises means for illuminating an object under inspection.

In another embodiment, the controller comprises means for illuminating an object under inspection; and wherein the controller comprises means for directing a different illumination colour for each of the plurality of captured images.

In a further embodiment, the controller comprises means for illuminating an object under inspection; and wherein the controller comprises means for directing a different illumination colour for each of the plurality of captured images; and wherein the controller comprises means for directing capture of a different number of images for each illumination colour.

In one embodiment, the image processor comprises means for interpolating additional pixels and for combining pixels of the captured images with said interpolated pixels to generate the output image.

In another embodiment, the image processor comprises means for interpolating additional pixels and for combining pixels of the captured images with said interpolated pixels to generate the output image; and wherein the captured images are captured before and after relative diagonal movement across a four-pixel grid to provide two captured pixels per four-pixel grid, and the remaining two pixels of the four-pixel grid are interpolated.

In a further embodiment, the movement means comprises means for tilting the camera lens between image acquisitions.

In one embodiment, the movement means comprises means for tilting the camera lens between image acquisitions; and said means comprises a piezo mover mounted on a lens clamp.

In another embodiment, the movement means comprises means for translationally shifting the camera lens between image acquisitions

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIGS. 1(a), 1(b), 1(c) and 1(d) are diagrams illustrating a camera movement sequence for acquisition of four images

FIGS. 2(a), 2(b), 2(c) and 2(d) are diagrams illustrating the four images captured during the movement sequence 1(a) to 1(d).

FIGS. 3(a) and 3(b) illustrate how a super-resolution image is assembled using pixels from the images 2(a) to 2(d).

FIGS. 4(a) and 4(b) are diagrams illustrating a camera movement sequence for acquisition of 2 images.

FIGS. 5(a) and 5(b) are diagrams illustrating the two images captured during the movement sequence 4(a) and 4(b).

FIG. 6(a) illustrates how a super-resolution image is formed using pixels from image 5(a) and 5(b), and FIG. 6(b) illustrates a further step of interpolation of missing pixels.

FIG. 7 is a diagram illustrating a camera movement sequence;

FIGS. 8(a) and 8(b) are diagrams illustrating photosensitive areas for image capture; and

FIGS. 9 to 12 are diagrams illustrating further movement sequences.

### DESCRIPTION OF THE EMBODIMENTS

A machine vision system for inspecting electronic circuits comprises a camera employing an image sensor that is made up of a number of imaging elements (pixels). When imaging an object these pixels have a finite resolution known as the pixel size. For a non-zoom optical system this is fixed. The system further comprises an X-Y table with a gantry. The gantry moves either the object or the camera, in this embodiment the camera. The system is capable of moving the camera or the object with movements which are less than one tenth of the pixel size. In another embodiment described below, only the lens is moved, this movement being with respect to the remainder of the camera.

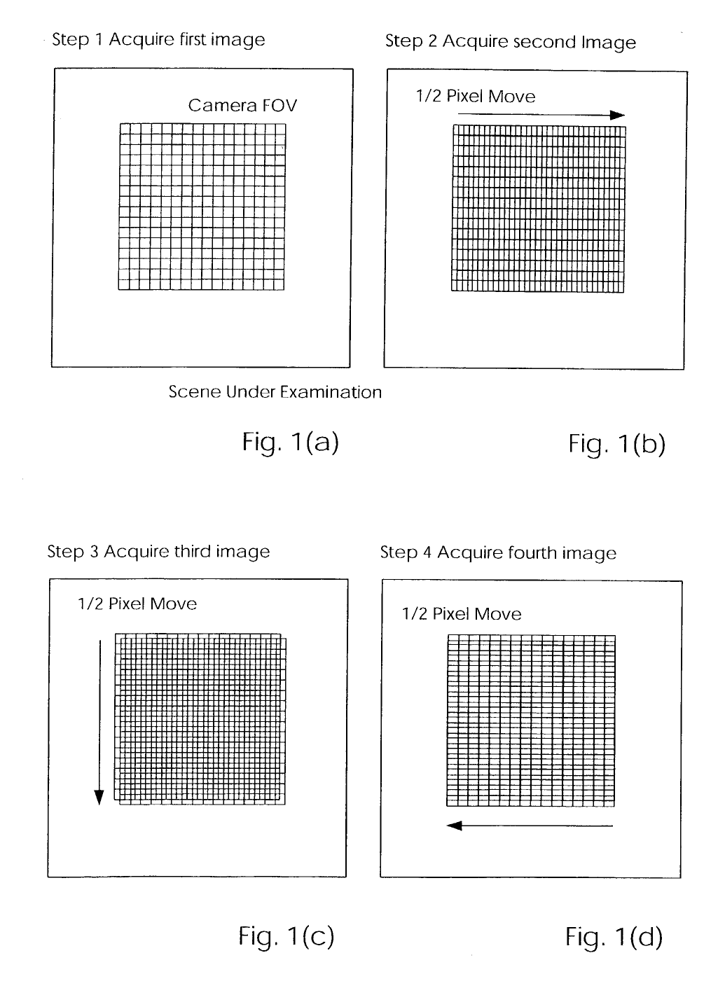

FIGS. 1 to 3 illustrate operation of the system for acquisition and generation of a super-resolution image based on four captured images. In this example four images are acquired from overlapping fields of view (FOV) and are combined to produce a single super-resolution image. The camera and object are displaced relative to each other in three short moves. The resultant image has four times the resolution of the original camera image. Also, it has twice the linear resolution of the original camera image. Referring to FIGS. 1(a) to 1(d) a camera movement sequence for acquisition of four images is illustrated. FIGS. 1(a) to 1(d) show the FOV of the scene under examination, FIG. 1(a) illustrates the initial FOV and FIGS. 1(b) to 1(d) show the FOV after movement.

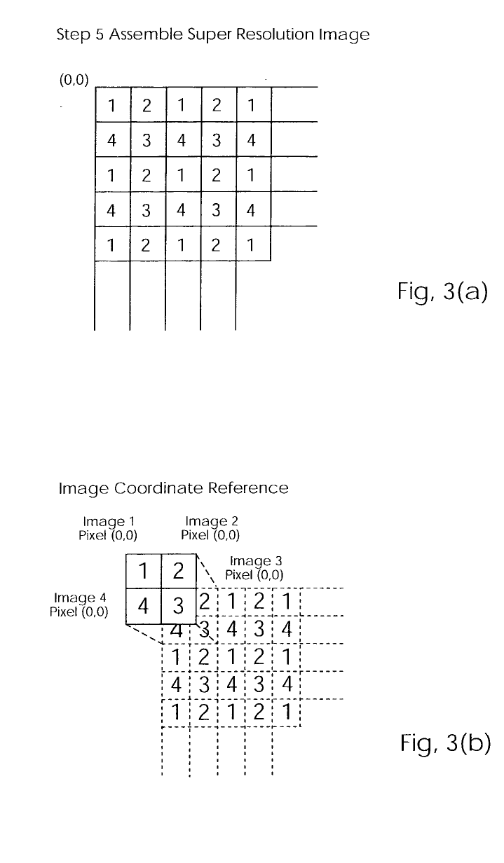

The following steps 1 to 4 of the sequence correspond to FIGS. 1(a) to 1(d) respectively. Step 5 is illustrated by FIGS. 3(a) and 3(b).

Step 1: Acquire and store first image.

Step 2: Move the camera right by ½ of a pixel width. Acquire and store the second image.

Step 3: Move the camera down by ½ of a pixel width. Acquire and store third image.

Step 4: Move the camera left by ½ of a pixel width. Acquire and store fourth image.

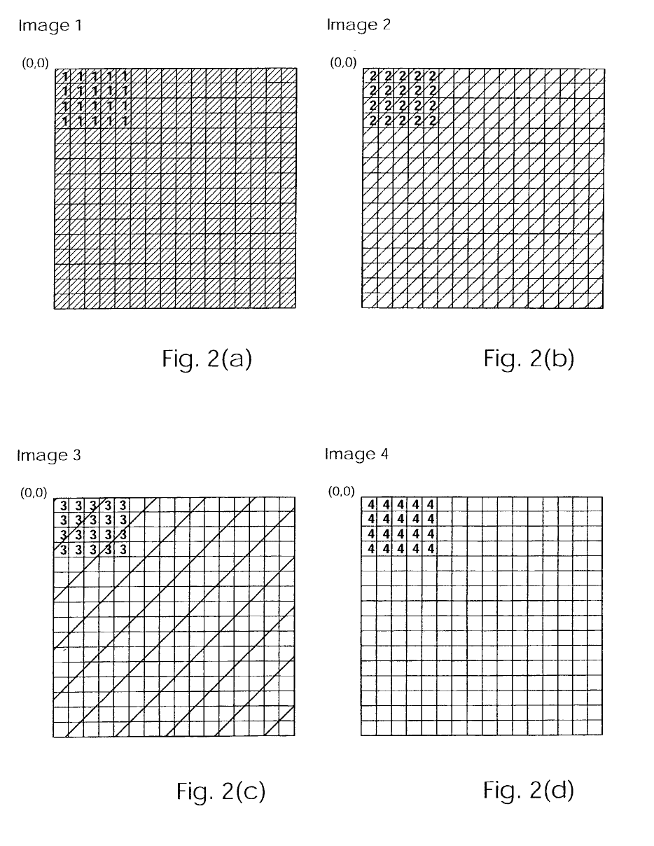

The memory of the system now contains four images. The four captured images 1, 2, 3 and 4 are illustrated in FIGS. 2(a) to 2(d).

Step 5: Relates to the composition of a super-resolution “view” image. Each individual pixel in each of the images 1, 2, 3 and 4 becomes a pixel in the super-resolution image. Referring to FIGS. 3(a) and 3(b), the method for composition of the super-resolution image is as follows. Starting at the upper left-hand corner, (0,0), pixels are inserted into the super-resolution images according to the sequence shown in the image co-ordinate reference. The insertion position of each pixel is made according to the move sequence used to acquire the images. This pattern is repeated until all pixel locations in the super-resolution image are filled.

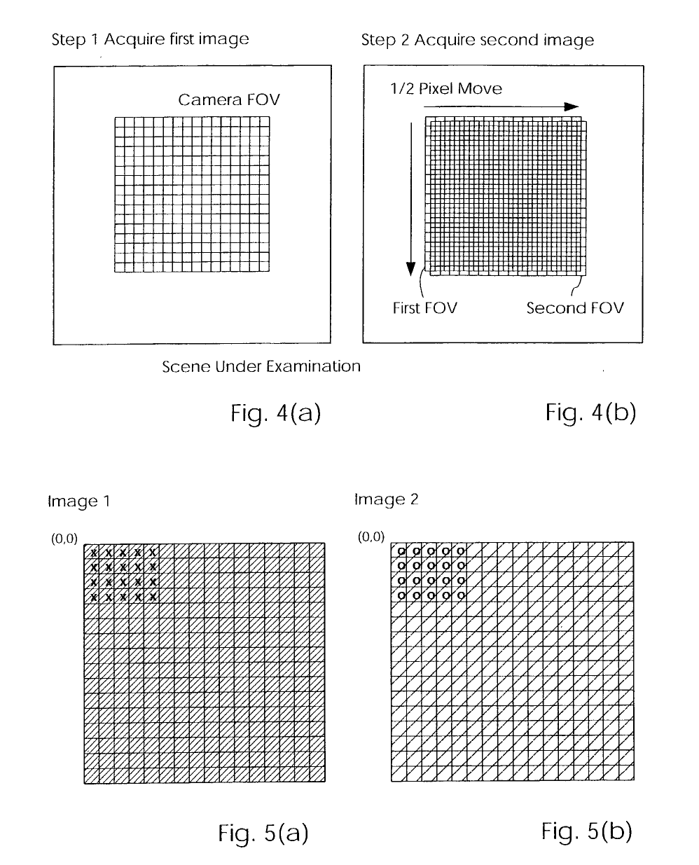

In a further embodiment, a system of the invention creates an image with four times the pixel count of the original while using only two captured images. FIGS. 4 to 6 illustrate a method for generation of a two-image super-resolution image. This method has the advantage that is twice as quick as the above four-image method.

FIGS. 4(a) and 4(b) illustrate the sequence of movement for capturing two images. The process involves the following steps:

Step 1: Acquire and store first image.

Step 2: Move the camera right by ½ a pixel width and down by ½ a pixel width Acquire and store second image.

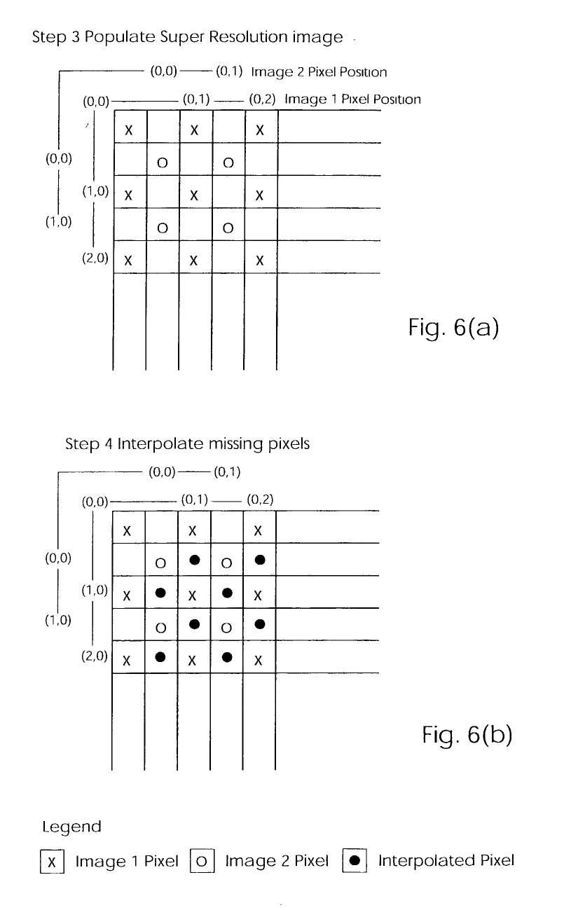

At this stage the vision system memory contains two images, images 1 and 2 as illustrated in FIGS. 5(a) and 5(b). The method for creating the super-resolution image is illustrated by FIGS. 6(a) and 6(b). This involves the following steps:

Step 3: The super resolution images is populated. Pixels are inserted from images 5(a) and 5(b) according to a checker board pattern as shown in FIG. 6(a). Starting at the upper left-hand corner (0,0), firstly pixels from image 5(a) are inserted and next the pixels from image 5(b) are inserted until all pixel positions are filled.

In the method of this embodiment, which is based on the use of two overlapping images, it is noted, as illustrated in FIG. 6(a) that half of the image contains no original image data. The missing pixels are interpolated as follows.

Step 4: As illustrated in FIG. 6(b), the missing pixels are interpolated from the surrounding north, south, east and west pixels. The interpolated pixel is then placed in the empty location.

The machine vision system is not limited to the methods of acquisition of two or four images to create a super-resolution image. For example, if the system is capable of sufficiently fine relative movements, then the system may acquire nine images (using moves of ⅓ of a pixel width) in order to produce a super resolution of three times the linear resolution of the original.

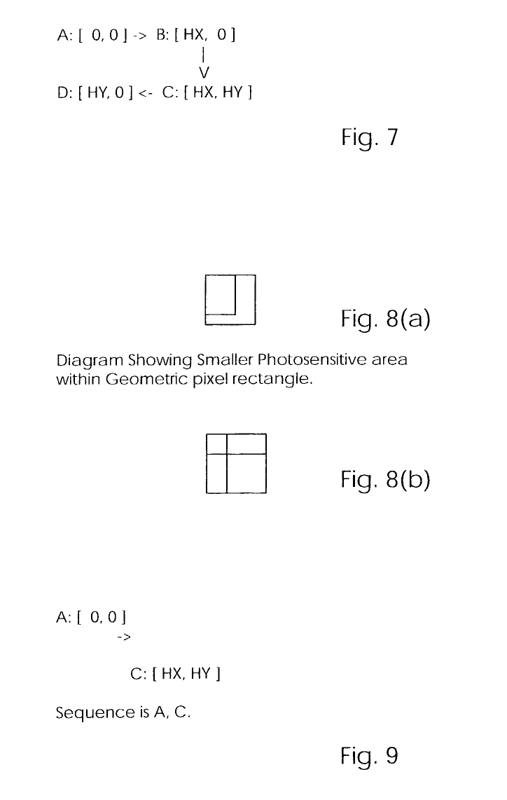

Further embodiments of the system are illustrated with reference to FIGS. 7 to 12. In one embodiment, the optical resolution is 25 microns. The camera is controlled to acquire four images at each “location”, each 12.5 microns apart in X and Y. The four 25 micron resolution images are combined to form a single 12.5 micron image.

The view-to-view move time is unchanged at 200 msec, while the acquisition time is increased to 200 msec to acquire four images. The system performs the small moves in less than the sensor readout time (45 msec), and thus this has no effect on the total image acquisition time. Thus the system can perform 2.5 views/second and inspect the board in 40 seconds, almost twice as fast as the prior “optical high resolution” situation.

Let us call the figure of 12.5 microns HX (and also HY) for Half X pixel (and Half Y pixel). The move sequence is as set out in FIG. 7. The moves are carried out in the sequence A B C D.

If the camera is twice as fast (25 msec to acquire an image), the system can inspect the board in 30 seconds or 3.3 views/second or 2.2 times as fast as the high resolution case. There are three further advantages:

A: The system can inspect larger parts without “breaking them up” between views which allows more robust vision algorithms to be used.

B: The system does not require hardware modification to achieve this increase in resolution, and thus it is easier to upgrade existing machines.

C: The system can mix high and normal resolution views in the same inspection program in any order. Suppose there are small parts in 20 percent of the views on the board, the system would only have to acquire the extra images for these views, further speeding up its operation. We can consider this a “mechanical zoom” system, which can be added to the system by a software addition.

The performance of the system is further enhanced by the “fill factor” of a CCD sensor when it is less than 100%. The surface of a CCD sensor is covered with pixels in a rectangular array, where each pixel consists of a photosensitive area and a non-photosensitive area. The ratio of the photosensitive area to the total pixel size is called the “fill factor”. This is usually less than 100%, typically 70-80%, but in some cases as low as 40%. The lower the value (to a minimum of 25%) the better because when the system moves the camera, it sees different object areas, as shown in FIGS. 8(a) and 8(b).

The invention is not limited to the embodiments described. For example, the resolution is not necessarily doubled. It could be tripled by taking 9 images ⅓ pixel apart in X and Y. Also, colour images may be acquired simultaneously by switching the lighting colours between each move, such as:

Green [0,0]

Red [1,0]

Green [1,1]

Blue [0,1]

Thus, the system could acquire colour and higher resolution at the same time. However, chromatic aberration might reduce the accuracy in some situations.

It is not essential to acquire four images to double the resolution. The system may just acquire 2 images at [0,0] and [HX,HY], and interpolate the other two points at [0,HY] and [HX,0]. This would make the acquisition twice as fast as taking 4 images, and would give an intermediate amount of detail, between taking 1 image and taking 4 images.

In addition, in this case, the system can modify out standard horizontal and vertical vector reading algorithms, which read image regions N pixels wide to a linear vector of pixels, to only read the “real” pixels, and to ignore the interpolated pixels.

In this case, the system can maintain the full resolution in X and Y, while only taking 2 images. The sequence is as shown in FIG. 9.

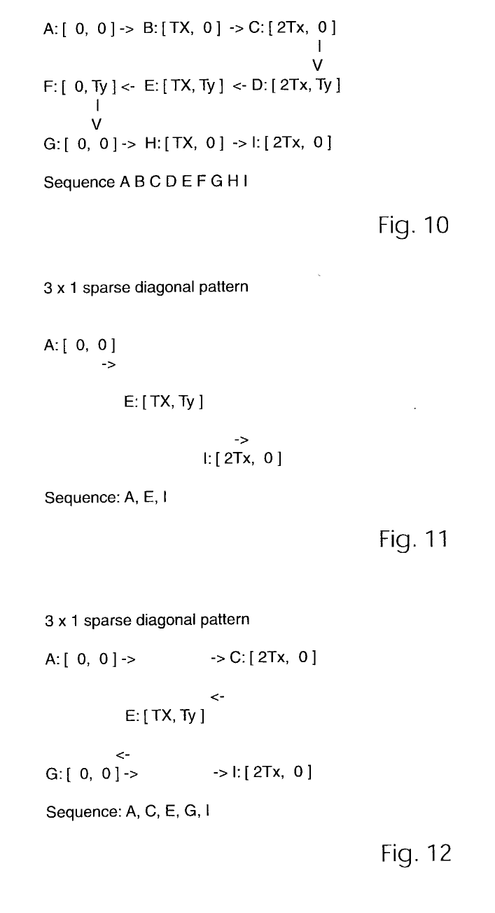

Similarly, it is not essential to acquire 9 images to triple the resolution of the system. It could acquire 3 images in a diagonal, or 5 images in two diagonals. (TX=⅓ X, TY=⅓ Y), and a sequence is illustrated in FIG. 10 for a 3×3 dense pattern. A 3×1 sparse patterns are shown in FIGS. 11 and 12.

It is also envisaged that the lens may be moved such as by tilting with respect of the camera, without moving the larger and heavier XY table. Suppose a 2:1 reduction is required (i.e. the camera sensor pixel size is 12 microns and the object pixel size is 24 microns. Half an object pixel would be 12 microns, so if we assume that the lens tilts linearly, the camera must shift the focal point of the lens by 6 microns. This can be achieved by using a piezo electric mover on the lens clamp. The advantage of this is that the XY table does not need to be moved and the mass to be moved is much less.

Alternately, the piezo mover could shift (rather than tilt) the lens to achieve this movement in an XY extension tube system.

Also, the system can be used for “split axis” systems as well as XY table systems. A split axis system is one where one axis (say X) is used to move the camera (at the “top” of the machine ) and the other axis (say Y) is used to move the object (printed circuit board) at the bottom of the machine. The principle is the same.

Also, the controller may “know” which views require higher (2× or 3×) resolution images and which do not, and only performs the high resolution on the views which require it. The may be a function implementing an algorithm for deciding which components require higher resolution inspection based on their body width or lead width, to enable the system to mark which views require high resolution inspection. Alternatively, the high/low resolution decision may be driven directly from the circuits CAD or other design data.

A function may read horizontal and vertical image vectors from the interpolated image, using only the “real” data.

If the system is to acquire a sequence of images with different characteristics (for instance different coloured lighting or different angled lighting), it does not have to acquire all of the images with four captured shifted images, it might only use four captured images for the most important image and use two captured images for the others. For instance, suppose the system were acquiring three images (Red, Green and Blue) to generate a colour image, where the red images was the most important image (primary image), it might acquire the red image with four shifted images and the green and blue with two each, thus reducing the number of images acquired from 12 to 8. It might even be possible to acquire 4, 1, 1 images to yield a total of 6 images.

The piezo mover could be a single axis mover, where the piezo axis would be parallel to the XY table.

It will be appreciated that the invention achieves excellent versatility for machine vision inspection. By simply controlling existing camera and gantry systems in a particular manner much higher effective resolution can be achieved. This higher resolution can be dynamically selected according to regions of the object under inspection, such as different components on a board. Also, the extent of higher resolution can be dynamically modified by changing the extent of offset movement between acquisitions (e.g. one-half pixel or one-third pixel).

The invention is not limited to the embodiments described but may be varied in construction and detail.

1. A machine vision system comprising:
a controller;
a camera having a lens, and being for capturing images of an object under inspection;
movement means to change mutual position of the camera with respect to the object under inspection;
an image processor for processing the captured images;
the movement means comprising means for moving relative position of the camera with respect to the object to the extent of less than a camera pixel dimension;
the controller comprising means to direct the movement means and the camera to capture a plurality of images mutually offset by a fraction of a pixel; and
the image processor comprises means for combining said plurality of captured images to provide an output image having a higher resolution than the captured images.

2. A system as claimed in claim 1, wherein the captured images are offset by one half of a pixel width.

3. A system as claimed in claim 1, wherein the captured images are offset by one third of a pixel width.

4. A system as claimed in claim 1, wherein the controller comprises means for dynamically controlling the movement means and the camera to capture a plurality of images offset by less than a pixel for a part of the object and to capture only one image for another part of the object.

5. A system as claimed in claim 4, wherein the controller comprises means for selecting an electronic component of a circuit object under inspection for capture of a plurality of images offset by less than a pixel.

6. A system as claimed in claim 1, wherein the controller comprises means for selecting an electronic component of a circuit object under inspection for capture of a plurality of images offset by less than a pixel; and wherein the controller comprises means for dynamically choosing which components require higher resolution inspection according to component attributes.

7. A system as claimed in claim 1, wherein the controller comprises means for selecting an electronic component of a circuit object under inspection for capture of a plurality of images offset by less than a pixel; and wherein the controller comprises means for choosing which components require higher resolution inspection according to circuit design data.

8. A system as claimed in claim 1, wherein the controller comprises means for illuminating an object under inspection.

9. A system as claimed in claim 1, wherein the controller comprises means for illuminating an object under inspection; and wherein the controller comprises means for directing a different illumination colour for each of the plurality of captured images.

10. A system as claimed in claim 1, wherein the controller comprises means for illuminating an object under inspection; and wherein the controller comprises means for directing a different illumination colour for each of the plurality of captured images; and wherein the controller comprises means for directing capture of a different number of images for each illumination colour.

11. A system as claimed in claim 1, wherein the image processor comprises means for interpolating additional pixels and for combining pixels of the captured images with said interpolated pixels to generate the output image.

12. A system as claimed in claim 1, wherein the image processor comprises means for interpolating additional pixels and for combining pixels of the captured images with said interpolated pixels to generate the output image; and wherein the captured images are captured before and after relative diagonal movement across a four-pixel grid to provide two captured pixels per four-pixel grid, and the remaining two pixels of the four-pixel grid are interpolated.

13. A system as claimed in claim 1, wherein the movement means comprises means for tilting the camera lens between image acquisitions.

14. A system as claimed in claim 1, wherein the movement means comprises means for tilting the camera lens between image acquisitions; and said means comprises a piezo mover mounted on a lens clamp.

15. A system as claimed in claim 1, wherein the movement means comprises means for translationally shifting the camera lens between image acquisitions.
